(19) United States
(12) Patent Application Publication
(10) Pub. No.: US 2025/0361976 A1
(43) Pub. Date: Nov. 27, 2025

(54) ADJUSTABLE UNIVERSAL SUPPORT

(71) Applicant: Wuxi Haoxiu Building Materials Technology Co., Ltd., Wuxi (CN)

(72) Inventor: Qunyu Xue, Wuxi (CN)

(21) Appl. No.: 18/781,092

(22) Filed: Jul. 23, 2024

(30) Foreign Application Priority Data
May 27, 2024 (CN) 2024211702628

(51) Int. Cl. F16M 11/24

(52) U.S. Cl. CPC F16M 11/24

(57) ABSTRACT

An adjustable universal support, comprising a top base, an adjusting portion, a heightening member, and a bottom base; on top base is sanp-fitted with dividing pieces, bottom end of top base is disposed within adjusting portion and is threadedly connected to adjusting portion, bottom end of adjusting portion is disposed within heightening member and is threadedly connected to heightening member, and bottom end of heightening member is threadedly connected to bottom base; adjusting portion comprises a plurality of screw elements of gradual change in size sleeved in sequence and any two adjacent screw elements are in threaded connection, and adjusting portion is telescopic along axial direction of screw elements; bottom end of screw element located on upper side of adjacent screw elements is equipped with snap fastener, and screw element on lower side is provided with a straight surface groove to fit with snap fastener.

### TECHNICAL FIELD

The invention relates to the technical field of supporting tools, in particular to an adjustable universal support.

### BACKGROUND ART

Universal support, with scientific name “adjustable support base”, is also widely known as “universal support” at present; the universal support is mainly used for off-contact ground support, which is designed for landscape architecture, mirror-like waterscape, roof gardens, wooden platforms, off-contact grille floor, plaza, dry fountain, interior decoration, balcony decoration, assembled houses and other projects research and design; universal support products focus on simple, practical, and adjustable system height.

At present, when assembling a plurality of stone panels or wood panels into a suspended foundation table, it is necessary to install a support at bottom of panels for support; in use, first of all, in order to determine the placing position of the support, starting position is firstly to be determined, pull the horizontal line and gridding; secondly, the supports will be temporarily placed on the grid, placing stones or wood panels on the support, placing a gradienter on the stones or wood panels, observing the gradienter and adjusting level of the stones and wood panels by adjusting the supports one by one, then, after stones and wood panels are placed, repeat the adjustment of slope gradient, use the gradienter and placing other stones and wood panels at the same time, generally a panel needs to be supported by at least four supports for each top corner or side to ensure its stability.

Most of the existing universal supports need to be assembled and disassembled to achieve adjustment of the highest height and lowest height adjustment, which wastes time and is very inconvenient, resulting in low practicability, and it wastes encasement space in the process of transportation, greatly increasing the logistics and packaging costs.

At the same time, when the universal support in prior art adjusts height, it's prone to cause falling off due to rotation between a bottom base and support, or what is even worse is that the thread is nearly falling off (the last 1 to 2 teeth remaining), but it cannot be detected from the appearance, resulting in the whole set of system falling down due to load-bearing and can not be found in a timely manner, which is very easy to cause accidents.

Therefore, an adjustable universal support is proposed to solve the current shortcomings.

### SUMMARY OF THE INVENTION

The technical problem to be solved by the invention is to overcome the above technical shortcomings and provides an adjustable universal support.

In order to solve said technical problem, the technical solution provided by the invention is an adjustable universal support, comprising a top base, an adjusting portion, a heightening member, and a bottom base;

on the top base is sanp-fitted with dividing pieces, a bottom end of the top base is disposed within the adjusting portion and is threadedly connected to the adjusting portion, a bottom end of the adjusting portion is disposed within the heightening member and is threadedly connected to the heightening member, and a bottom end of the heightening member is threadedly connected to the bottom base;

the adjusting portion comprises a plurality of screw elements of gradual change in size sleeved in sequence and any two adjacent screw elements are in threaded connection, and the adjusting portion is telescopic along axial direction of the screw elements;

a bottom end of the screw element located on an upper side of adjacent screw elements is equipped with a snap fastener, and the screw element located on a lower side is provided with a straight surface groove to fit with the snap fastener.

As an improvement, the screw element located at a lower end of the adjusting portion is screwed counterclockwise to the heightening member, and said heightening member is screwed counterclockwise to the bottom base.

As an improvement, a bottom end of said top base is provided with a second snap fastener that fits into the straight surface groove.

As an improvement, a cross-shaped support member is provided at an upper part inside the heightening member.

As an improvement, the top base is in the form of a petal-like structure, and a grille ring is provided on an outside of the top base.

As an improvement, a screwing portion is provided at an outer upper part of the screw element located at the lower end of the adjusting portion.

Compared with the prior art, the invention has the following advantages:
1. The height adjustment of the support can be realized through rotation between the top base and adjusting portion, and between the screw elements in the adjusting portion, and at the same time, through the contraction of the support, the space occupied can be reduced, and the encasement space can be saved, which greatly reduces the cost of logistics and packaging;
2. The firmness of connection of the support in the unfolding process can be ensured by counterclockwise screwing between the screw elements at the lower end of the adjusting portion and the heightening member, and between the lower end of the heightening member and the bottom base;
3. The support is simple in structure and easy to use, and retractility and stability of the structure are ensured at the same time, and its telescopic form greatly reduced cost of packaging and transportation, which has a great promotion and application value.

### BRIEF DESCRIPTION OF ACCOMPANY DRAWINGS

FIG. 1 is a structural diagram of the adjustable universal support provided by the invention;

FIG. 2 is a structural diagram of the adjustable universal support in contraction state provided by the invention;

FIG. 3 is an exploded view of the adjustable universal support provided by the invention;

FIG. 4 is a partial enlarged view of of position A in FIG. 3;

FIG. 5 is a structural connecting diagram between screw elements of the adjustable universal support provided by the invention.

FIG. 6 is a partial enlarged view of of position B in FIG. 5.

As shown in the accompanying drawings: 1 top base, 2 adjusting portion, 201 screw element, 3 heightening member, 4 bottom base, 5 dividing piece, 6 snap fastener, 7 straight surface groove, 8 cross-shaped support member, 9 grille ring, 10 screwing portion, 11 second snap fastener.

### SPECIFIC EMBODIMENT OF THE INVENTION

In order to make the objects, technical solutions and advantages of the embodiments of the present invention clearer, the technical solutions in the embodiments of the invention will be clearly and completely described below with reference to the drawings in the embodiments of the invention, and it is obvious that the described embodiments are some, but not all, embodiments of the invention. The components of embodiments of the invention generally described and illustrated in the figures herein may be arranged and designed in a wide variety of different configurations.

Thus, the following detailed description of the embodiments of the invention, presented in the figures, is not intended to limit the scope of the invention, but is merely representative of selected embodiments of the invention. All other embodiments, which can be derived by a person skilled in the art from the embodiments given herein without making any creative effort, shall fall within the protection scope of the invention.

It should be noted that: similar reference numbers and letters refer to similar items in the following figures, and thus, once an item is defined in one figure, it need not be further defined and explained in subsequent figures.

In the description of the embodiments of the invention, it should be noted that, if the terms “center”, “on”, “below”, “left”, “right”, “vertical”, “horizontal”, “inner”, “outer”, etc. indicate orientations or positional relationships based on the orientations or positional relationships shown in the drawings or the orientations or positional relationships that the products of the invention are usually placed in when used, the orientations or positional relationships are only used for convenience of describing the invention and simplifying the description, but the terms do not indicate or imply that the devices or elements indicated must have specific orientations, be constructed in specific orientations, and operate, and therefore, should not be construed as limiting the invention. Furthermore, the terms “first”, “second”, “third” and the like are used solely to distinguish one from another and are not to be construed as indicating or implying relative importance.

Furthermore, the terms “horizontal”, “vertical”, “overhang” and the like do not require that the components be absolutely horizontal or overhang, but may be slightly inclined. For example, “horizontal” merely means that the direction is more horizontal than “vertical” and does not mean that the structure must be perfectly horizontal, but may be slightly inclined.

In the description of the embodiments of the invention, “a plurality” represents at least 2.

In the description of the embodiments of the invention, it should be further noted that unless otherwise explicitly stated or limited, the terms “arranged”, “mounted”, and “connected” should be interpreted broadly, and may be, for example, fixedly connected, detachably connected, or integrally connected; can be mechanically or electrically connected; they may be connected directly or indirectly through intervening media, or they may be interconnected between two elements. The specific meanings of the above terms in the invention can be understood by those skilled in the art according to specific situations.

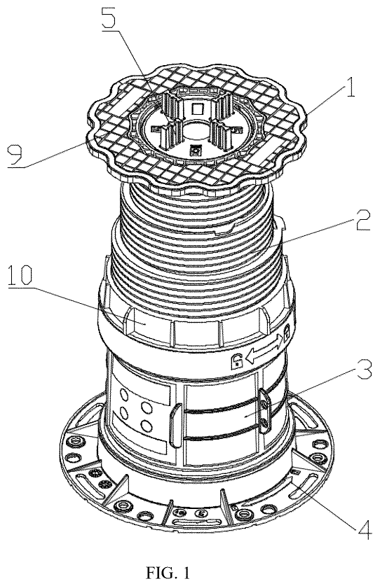

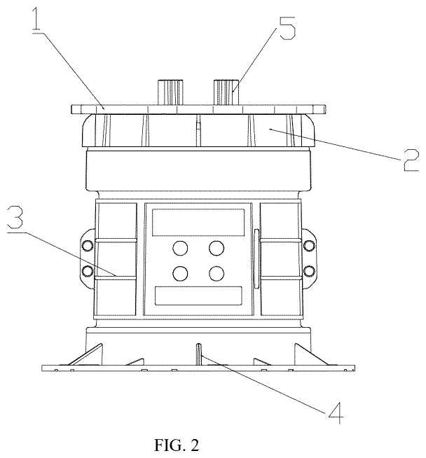

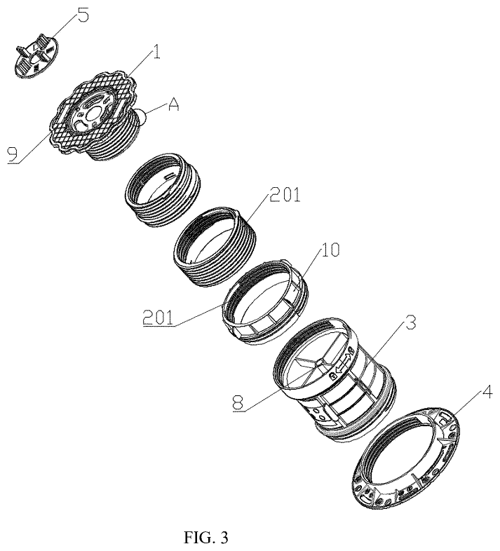

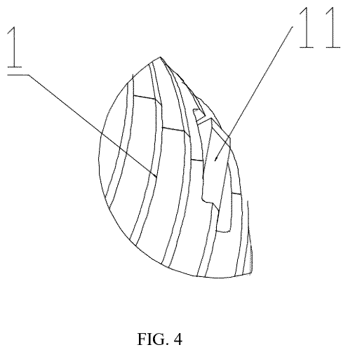

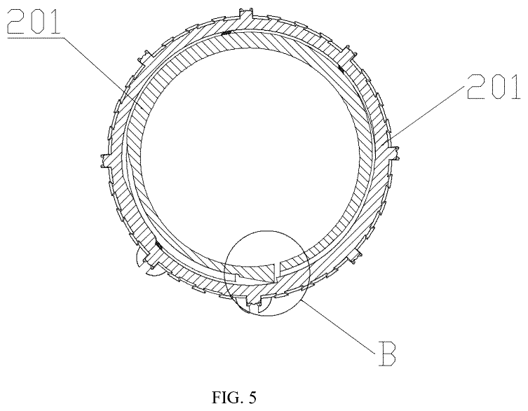

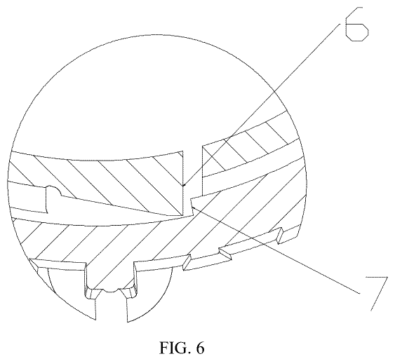

With reference to FIGS. 1 to 6, an adjustable universal support, comprising a top base 1, an adjusting portion 2, a heightening member 3, and a bottom base 4;

on the top base 1 is sanp-fitted with dividing pieces 5, specifically, detachable connection between the top base 1 and the dividing pieces 5 realized by means of snap fasteners;

In implementation, an adjusting key is used to cooperate with the dividing pieces 5, and rotating the adjusting key to realize rotating operation of the dividing pieces 5, and then, adjustment of contraction state of the support can be realized by rotating the dividing pieces 5 positively and negatively.

Further, the top base 1 is in the form of a petal-like structure, and a grille ring 9 is provided on an outside of the top base 1.

A bottom end of the top base 1 is disposed within the adjusting portion 2 and is threadedly connected to the adjusting portion 2, specifically, a lower end of the top base 1 is coaxially provided with a threaded section, and a lower end of the threaded section is located in the adjusting portion 2 and is threadedly connected with the adjusting portion 2, so that in the process of use, adjustment of relative height between the top base 1 and the adjusting portion 2 can be realized via rotating between the threaded section and the adjusting portion 2.

The adjusting portion 2 comprises a plurality of screw elements 201 of gradual change in size sleeved in sequence, specifically, the screw elements 201 is a columnar structure as a whole, and any two adjacent screw elements 201 are in threaded connection; in this embodiment, diameter of the screw element 201 located on an upper side of adjacent two screw elements 201 is smaller than diameter of the screw element 201 located on a lower side;

In implementation process, the adjusting portion 2 is telescopic along axial direction of the screw elements 201, and height of the support can be adjusted by rotation between adjacent screw element 201;

During specific operation, a mutual extension is realized to achieve an increase in height when clockwise rotation is made between said top base 1 and the adjusting portion 2, and between said screw elements 201 in the adjusting portion 2, and when they are subjected to counterclockwise between each other, a mutual contraction is realized to achieve a decrease in height.

A bottom end of the screw element 201 located on an upper side of adjacent screw elements 201 is equipped with a snap fastener 6, and the screw element 201 located on a lower side is provided with a straight surface groove 7 to fit with the snap fastener 6.

In implementation, when the adjacent screw elements 201 are rotated and are rotated to the highest position of the two, through cooperation between the snap fastener 6 and the straight surface groove 7, it can effectively prevent the adjacent screw elements 201 from being easily screwed out of each other in the using process, avoiding to cause falling off between the screw elements 201.

A screwing portion 10 is provided at an outer upper part of the screw element 201 located at the lower end of the adjusting portion 2 to facilitate threaded connection of the adjusting portion 2 and the heightening member 3 in assembling process of the support.

In implementation, a bottom end of said top base 1 is provided with a second snap fastener 11 that fits into the straight surface groove 7. Likewise, the cooperation of the second snap fastener 11 on the top base 1 with the straight surface groove 7 on the correspondingly connected screw elements 201 prevents falling off between the top base 1 and the screw elements 201 during use.

A bottom end of the adjusting portion 2 is disposed within the heightening member 3 and is threadedly connected to the heightening member 3, specifically, the screw element 201 located at a lower end of the adjusting portion 2 is screwed counterclockwise to the heightening member 3;

In the process of implementation, when clockwise rotation is carried out between the top base 1 and adjusting portion 2, and between the screw elements 201 in the adjusting portion 2, to realize extension of the support, due to the counterclockwise screwing between the screw element 201 located at the lower end of the adjusting portion 2 and the heightening member 3, firmness of connection between the adjusting portion 2 and the heightening member 3 can be ensured to avoid loosening or falling off between the heightening member 3 and the adjusting portion 2 during the use of the support.

Further, a cross-shaped support member 8 is provided at an upper part inside the heightening member 3, which can enhance structural strength of the heightening member 3 and further ensure overall structure stability.

A bottom end of the heightening member 3 is threadedly connected to the bottom base 4; specifically, the bottom end of the heightening member 3 is located in the bottom base 4 and is threadedly connected to the bottom base 4.

In the embodiment, said heightening member 3 is screwed counterclockwise to the bottom base 4.

In the process of implementation, when clockwise rotation is carried out between the top base 1 and adjusting portion 2, and between the screw elements 201 in the adjusting portion 2, to realize extension of the support, due to the counterclockwise screwing between the heightening member 3 and the bottom base 4, firmness of connection between the heightening member 3 and the bottom base 4 can be ensured to avoid loosening or falling off between the heightening member 3 and the bottom base 4 during the use of the support.

At the same time, in the process of use, the use of the heightening member 3 can be selected according to the actual supporting height; when the supporting height is lower, the screw element 201 at the lower end of the adjusting portion 2 can be threadedly connected to the bottom base 4 directly, at this time, the screw element 201 located at the lower end of the adjusting portion 2 is screwed counterclockwise to the bottom base 4, which can also ensure the connection firmness and stability between the screw element 201 located at the lower end of the adjusting portion 2 and the bottom base 4 in the process of extending the support.

In the specific implementation of the invention, when installing, the dividing pieces 5 are fastened to the top base 1 by means of snap fasteners to realize fixed connection between the two, and the bottom end of said top base 1 is threadedly connected to the screw element 201 at an upper end of the adjusting portion 2; the adjusting portion 2 comprises three screw elements 201 which are threaded with each other, and the adjusting portion 2 can be adjusted along an axis of the screw elements 201 for expansion and contraction. In the unfolding process between the screw elements 201 and between the screw elements 201 and the top base 1, when reaching the highest position, limitation between their mutual positions can be realized through the cooperation between the snap fastener 6 and the straight surface groove 7, so as to avoid causing falling off among them.

When not in use, the adjusting portion 2 can be contracted to realize that the screw element 201 located on upper side is screwed into the screw element 201 on bottom side, and at the same time, an lower part of the bottom base 1 is screwed into the correspondingly connected screw element 201, so as to realize retraction of the support, and at the same time, the heightening member 3 can be placed separately, and be set up according to the actual use, so as to make the product packed in the lowest possible height in the process of packaging and transporting the product, saving the encasement space and greatly reducing logistics and packaging costs;

At the same time, in the process of use, by rotating between the top base 1 and the adjusting portion 2, and between said screw elements 201 in the adjusting portion 2, adjustment of the highest height and the lowest height of the universal support can be realized, which saves time and improves practicability.

Moreover, the firmness of connection of the support during extension can be ensured by the counterclockwise screwing between the screw element 201 located at the lower end of said adjusting portion 2 and the heightening member 3, and between the lower end of the heightening member 3 and the bottom base 4;

Similarly, the screw element 201 located at the lower end of the adjusting portion 2 is screwed counterclockwise to the heightening member 3, and the lower end of the heightening member 3 is screwed counterclockwise to the bottom base 4, which means that the screw element 201 located at the lower end of the adjusting portion 2 is screwed counterclockwise to the bottom base 4, and it can also ensure the structural firmness and stability of when the screw elements 201 are connected with the base 4 directly.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. An adjustable universal support, comprising a top base, an adjusting portion, a heightening member, and a bottom base;
on the top base is sanp-fitted with dividing pieces, a bottom end of the top base is disposed within the adjusting portion and is threadedly connected to the adjusting portion, a bottom end of the adjusting portion is disposed within the heightening member and is threadedly connected to the heightening member, and a bottom end of the heightening member is threadedly connected to the bottom base;
the adjusting portion comprises a plurality of screw elements of gradual change in size sleeved in sequence and any two adjacent screw elements are in threaded connection, and the adjusting portion is telescopic along axial direction of the screw elements;
a bottom end of the screw element located on an upper side of adjacent screw elements is equipped with a snap fastener, and the screw element located on a lower side is provided with a straight surface groove to fit with the snap fastener.

2. The adjustable universal support of claim 1, wherein the screw element located at a lower end of the adjusting portion is screwed counterclockwise to the heightening member, and said heightening member is screwed counterclockwise to the bottom base.

3. The adjustable universal support of claim 1, wherein a bottom end of said top base is provided with a second snap fastener that fits into the straight surface groove.

4. The adjustable universal support of claim 1, wherein a cross-shaped support member is provided at an upper part inside the heightening member.

5. The adjustable universal support of claim 1, wherein the top base is in the form of a petal-like structure, and a grille ring is provided on an outside of the top base.

6. The adjustable universal support of claim 1, wherein a screwing portion is provided at an outer upper part of the screw element located at the lower end of the adjusting portion.
